(19) United States
(12) Patent Application Publication
(10) Pub. No.: US 2009/0104577 A1
(43) Pub. Date: Apr. 23, 2009

(54) Candle with an Embedded Magnet or Ferromagnetic Material

(76) Inventors: Devon C. Campbell, Oro Valley, AZ (US); Kurt Reinhardt, Tucson, AZ (US)

Correspondence Address: DEVON C. CAMPBELL, 11822 N. COPPER BUTTLE DR., ORO VALLY, AZ, 85737, US

(21) Appl. No.: 11/968,150

(22) Filed: Dec. 31, 2007

Related U.S. Application Data
(60) Provisional application No. 60/981,511, filed on Oct. 21, 2007.

(51) Int. Cl. F23D 3/16; C11C 5/00; B25B 11/00

(52) U.S. Cl. 431/289; 431/297; 269/8

(57) ABSTRACT

A candle is disclosed that contains a small magnet (or ferromagnetic material) embedded in the base of the candle. In one embodiment, the base of a cylindrical candle contains a magnet (or ferromagnetic material) molded into the body of the candle such that a face of the magnet (or ferromagnetic material) is substantially co-planar with the base of the candle. The magnet (or ferromagnetic material) can have an irregular cross section along the length of the candle, thereby aiding retention of the magnet (or ferromagnetic material) within the candle body.

### FIELD OF THE INVENTION

The present invention relates to candles, and more particularly to a wax candle that can be held magnetically to a support or holder without material alteration of the candle, and also to a method for securely attaching a candle to a holder or any of a variety of supports.

### BACKGROUND OF THE INVENTION

Methods of retaining and orienting candles typically require material alteration of a candle's base. In one instance, the base of a candle is deformed by pressing it onto a cup-like holder, a process that relies on the strength and dexterity of the user for reliable retention. Even if the cup and/or candle are shaped to assist in alignment or retention of the candle, the placed candle may appear to be well seated when actually it is held tenuously in place. Another method includes impaling the candle onto one or more spikes. Yet another method is the use of putty to stick a candle in a base. In these techniques, deformation of a candle into or onto a holder can compromise the structural integrity of the candle itself, and adhesive putties may not adhere the intended surfaces due to dirt, oil contamination, or aging of the putty material.

Wax can be melted into a holder and the candle placed against the melted wax in an effort to bond a candle to a holder, but material dissimilarities (including differences in rates of thermal expansion) between the holder and the candle typically results in poor adhesion of the candle to the holder. Adhesives can be used, but represent an additional and perhaps messy step in mounting a candle; additionally, obnoxious fumes may be released into the vicinity. Methods of magnetic attachment of a candle to a holder that include attaching a magnetic material to an already formed candle can compromise the structural integrity of the candle (e.g. split the base) if the magnetic material includes a spike that is pressed into the candle to attach the material.

Since the potential for an unplanned fire is present when a candle topples over, a more reliable way to secure a candle to a holder or a substrate without compromising its structural integrity is highly desirable. Furthermore, a candle that can be held in place on a variety of substrates (such as on a railing of a deck, or the hood of a car in an emergency), and that can be safely positioned at significant angles from vertical, helps safely extend the use of candles to more situations.

### SUMMARY OF THE INVENTION

A candle is disclosed that includes one or more magnets embedded in its base, and particularly, a candle including a magnet that is molded into the base of the candle during manufacture of the candle. Alternatively, a ferromagnetic material may be embedded into the candle, allowing it to be secured to a magnetic base. In one embodiment, the magnet (or ferromagnetic material) included in the candle has an irregular cross section along the length of the candle, thereby aiding retention of the magnet within the candle body. In another embodiment, the magnet (or ferromagnetic material) is encased in a shell material and is in turn embedded in the magnet. In yet another embodiment, the magnet (or ferromagnetic material) includes a planar surface and the magnet is molded into the candle such that the planar surface is coplanar with the base of the candle. Alternatively, the magnet (or ferromagnetic material) may protrude beyond the surface of the candle body. In particular embodiments, the planar surface of the magnet (or ferromagnetic material) is substantially the same size as the base of the candle into which it is molded, and in more particular embodiments, the magnet having a surface substantially the same size as the base of the candle extends irregularly into the body of the candle along the length of the candle. In even more particular embodiments, the planar surface of the magnet (or ferromagnetic material) is flush with the base of the candle, and in others, it is embedded some distance within the candle, such as 1 mm, 2 mm, 5 mm or perhaps more if the candle is large enough to accommodate a magnet of substantial size and strength to attach the candle to the holder or surface to which it is attracted. In another embodiment, the candle wick terminates before reaching the level of the magnet (or ferromagnetic material), so that a burning candle would self extinguish before reaching the magnetic base. Moreover, in a very large candle, several magnets may be placed in the base in a pattern to increase stability and holding power. A large number of substantially small magnets (or ferromagnetic materials) may also be distributed at constant or varying concentrations throughout the body of the candle, therein effectively making the entire candle appear to be magnetic. Other embodiments may include magnets (or a ferromagnetic material) embedded in a candle with the poles of the magnet normal to or otherwise not coaxial with the long axis of the candle, allowing the candle to be retained by a holder from somewhere other than its base.

The disclosed candle does not rely on pressing it into a cup or forcing it onto a spike to hold it in place, nor does it rely on melted wax or an adhesive to form a bond with a candleholder, or even to some extent gravity, to ensure its orientation and retention within in/on a holder or substrate. Rather, the embedded magnet (or ferromagnetic material) in the candle's base, when brought into proximity of a surface to which it is magnetically attracted, automatically orients the candle and couples it to the holder or substrate. The strength of the coupling can be adjusted by the size and strength of the magnet to suit a particular application. Likewise, the surface area of interaction between the magnet and the holder or substrate can be altered to adjust the strength of the coupling. For example, if the candle is to be used in a non-horizontal orientation such as attached to a non-horizontal substrate, a larger and/or stronger magnet could be incorporated into the candle. Non-horizontal substrates include inclined planes, round surfaces (such as rods, spheres, or cones), and irregularly shaped surfaces. Similarly, in order to provide a more secure attachment of a candle, a combination of a magnet extending along a candle from its base, and within a few millimeters from the sides of the base section of the candle, can be used in combination with a holder configured to enclose a length of the candle substantially similar to the length of the magnet along the length of the candle.

The disclosed candle permits for additional benefits during the manufacturing processes, whether manually or automated, wherein the bottom of the wick can be secured and positioned within the mold when fixedly attached to a material attracted to the magnet (or ferromagnetic material). Said material may be later removed (such as with thin rods or thin plates) or left inside the wax.

The disclosed candle allows for improved placement and positioning on or within decorative or utilitarian substrates as the magnet (or ferromagnetic material) is inherently self-aligning.

### Current State of the Art and Detailed Description

Therefore the present invention provides a means of orienting and securing a candle to a ferromagnetic base that does not require melting the candle or impaling the candle. Likewise, a candle may be secured to a magnetic base. Other and further objects and advantages will appear hereinafter.

The magnet (or ferromagnetic material) may be embedded in the candle when the candle is formed, or the magnet may be placed there in a secondary operation. The magnet (or ferromagnetic material) is small enough with respect to the candle that it is contained within the candle's body, and the wall thickness at the base, which surrounds the magnet, does not compromise the structural integrity of the candle. The magnet may be a permanent magnet of the classes: Neodyium Iron Boron, Samarium Cobalt, Alnico, Ceramic, or Ferrite.

Thus a candle design is disclosed which retains a candle to a ferromagnetic base without the need to alter the candle's base. Likewise, a candle with an embedded ferromagnetic material may be retained by a magnetic base. While embodiments and applications of this invention have been shown and described, it would be apparent to those skilled in the art that many more modifications are possible without departing from the inventive concepts herein. The invention, therefore, is not to be restricted except in the spirit of the appended claims.

### BRIEF DESCRIPTION OF THE DRAWINGS

FIG. 1 is a perspective view of an embodiment of the disclosed candle.

FIG. 2 shows an embodiment of a magnet (or ferromagnetic material) imbedded in a candle that includes an irregular shape along the length of the candle.

FIG. 3 shows various irregularly shaped magnets (or ferromagnetic materials) to improve retention within candle.

FIG. 4 shows a candle with at least one embedded magnet (or ferromagnetic material) embedded to allow the candle to be held to a holder by a force lateral to the long axis of the candle.

FIG. 5 shows a candle with a magnet and larger piece of a ferromagnetic material (like carbon steel) magnetically attracted to the one side of the magnet on the end embedded in the candle) and this is all the retainer we need. We could also use a thin walled hollow tube set 90 degrees resting on top of the magnet. Point is, we can use off the shelf magnets with no danger of them falling out. The other thing I realized.

### DETAILED DESCRIPTION OF ILLUSTRATIVE EMBODIMENTS

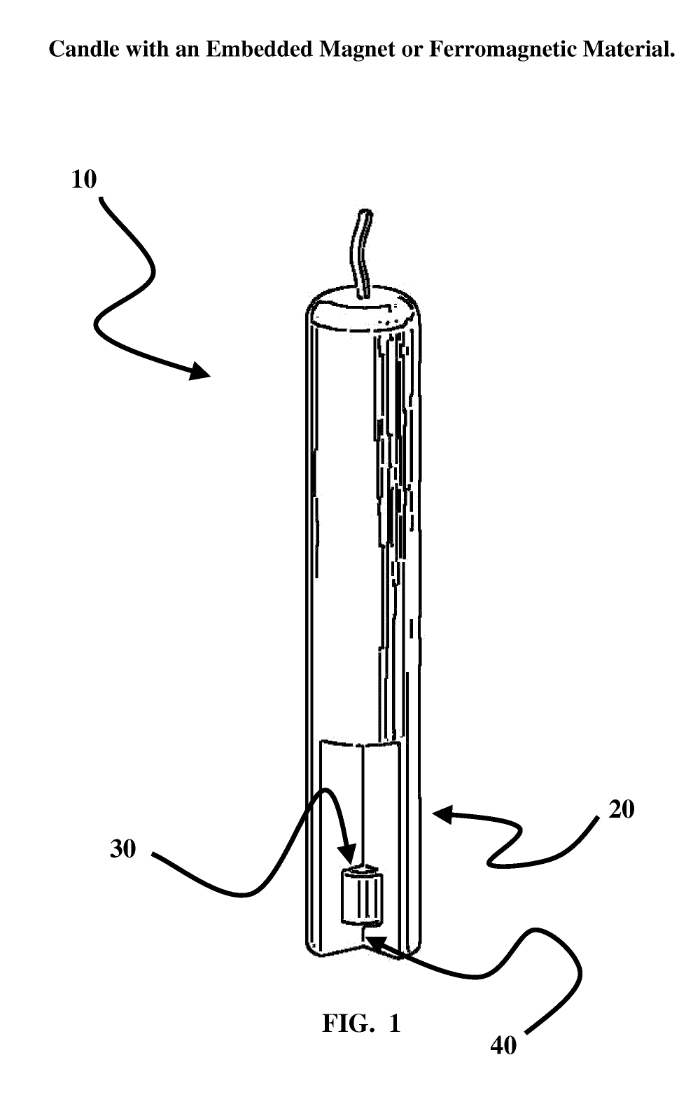

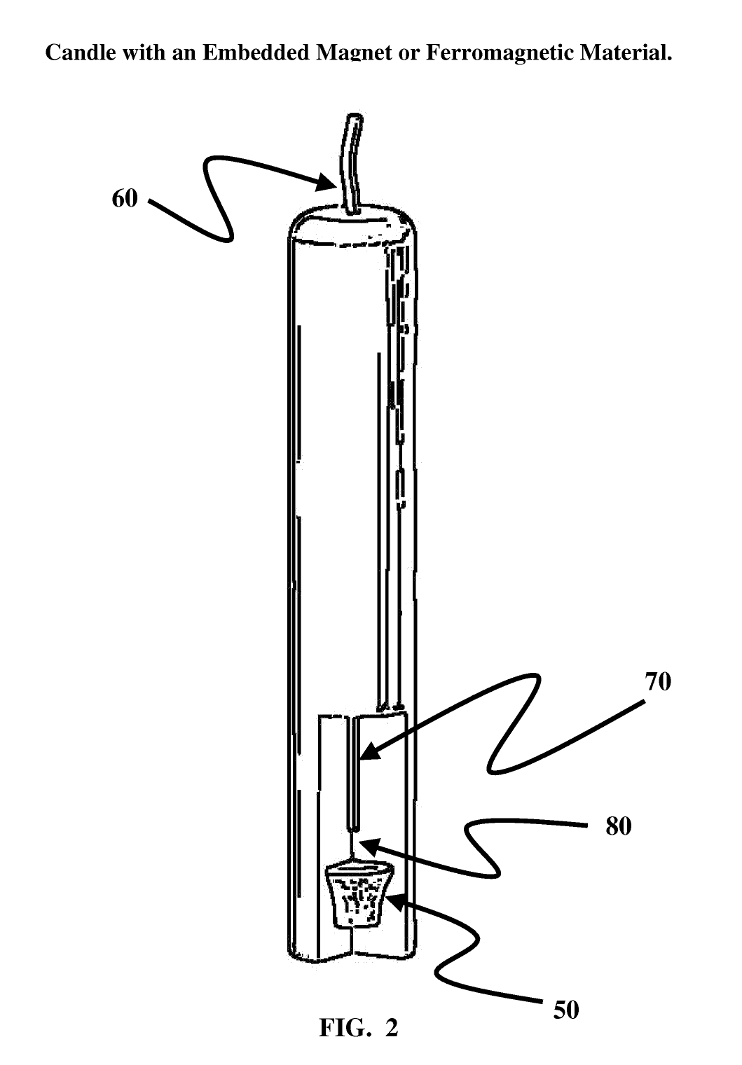

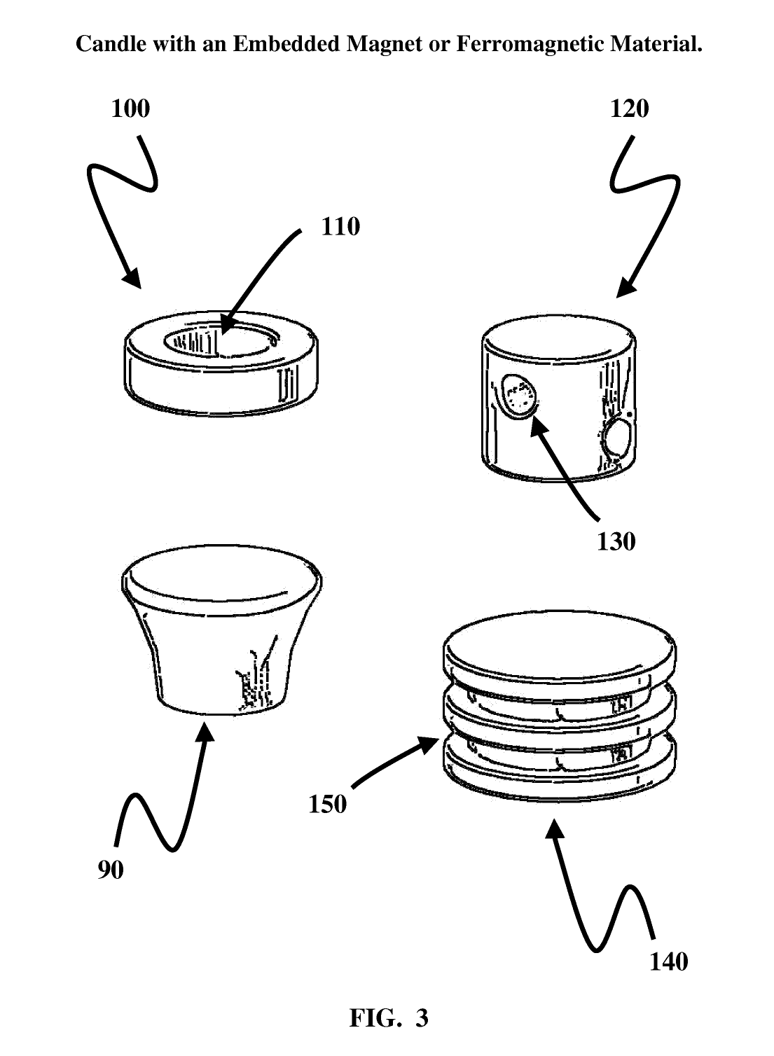

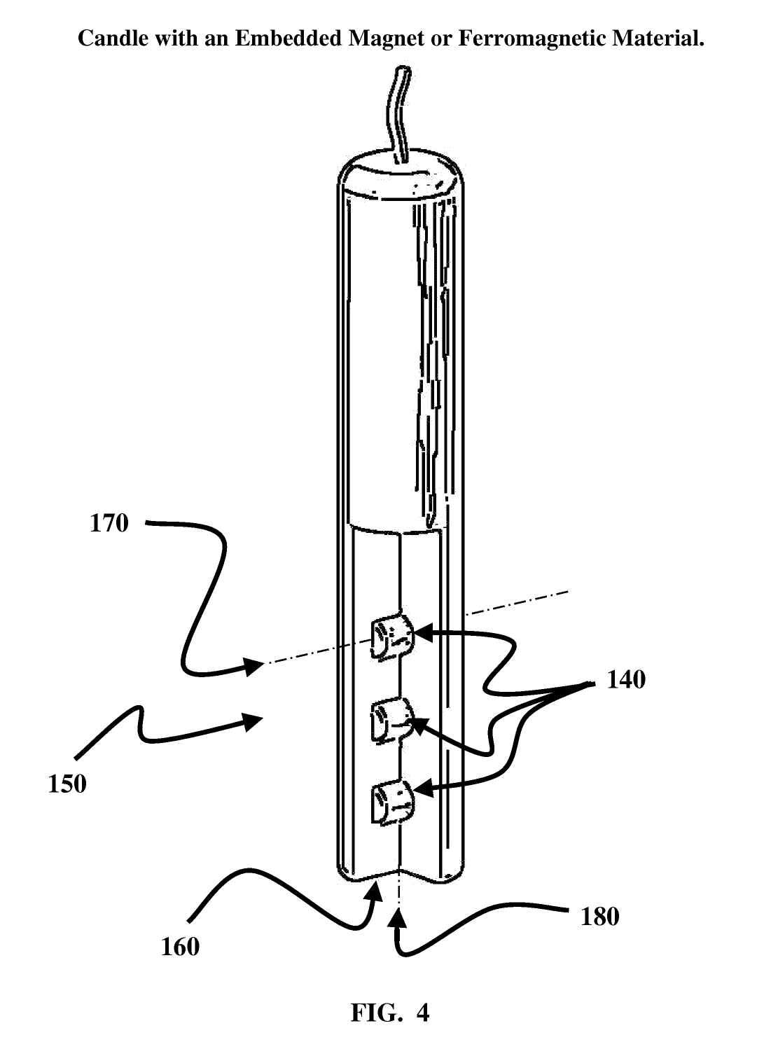

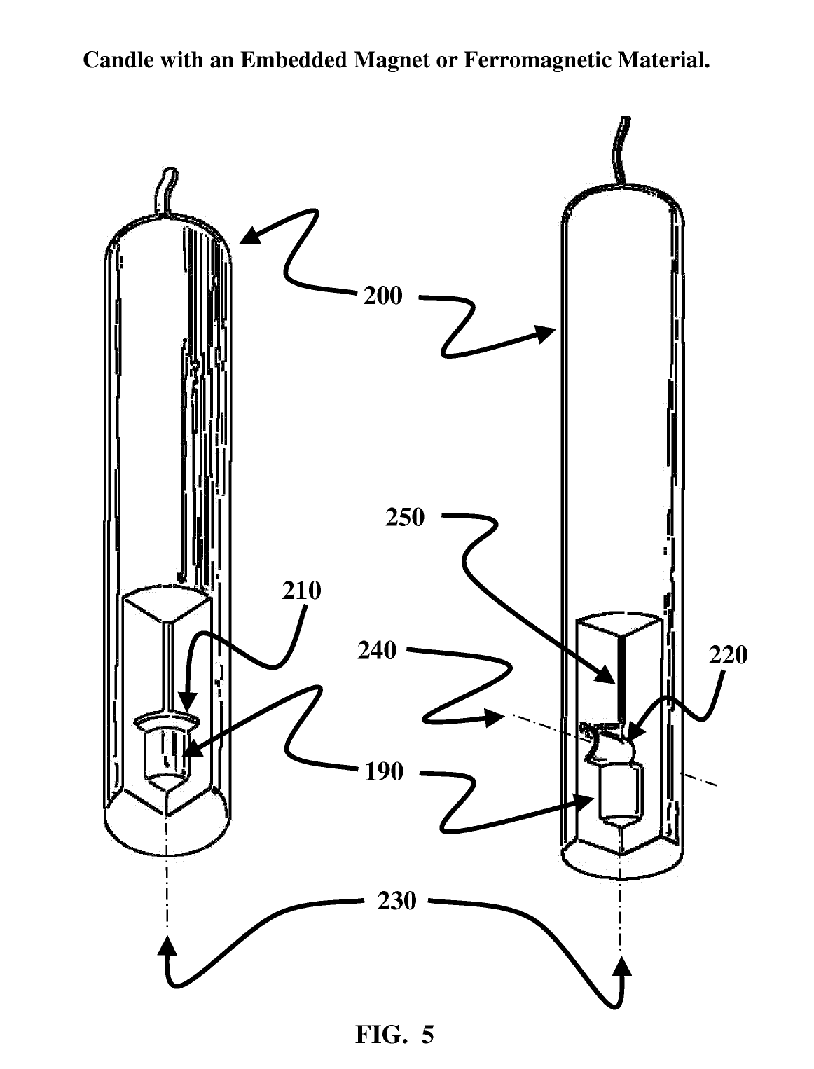

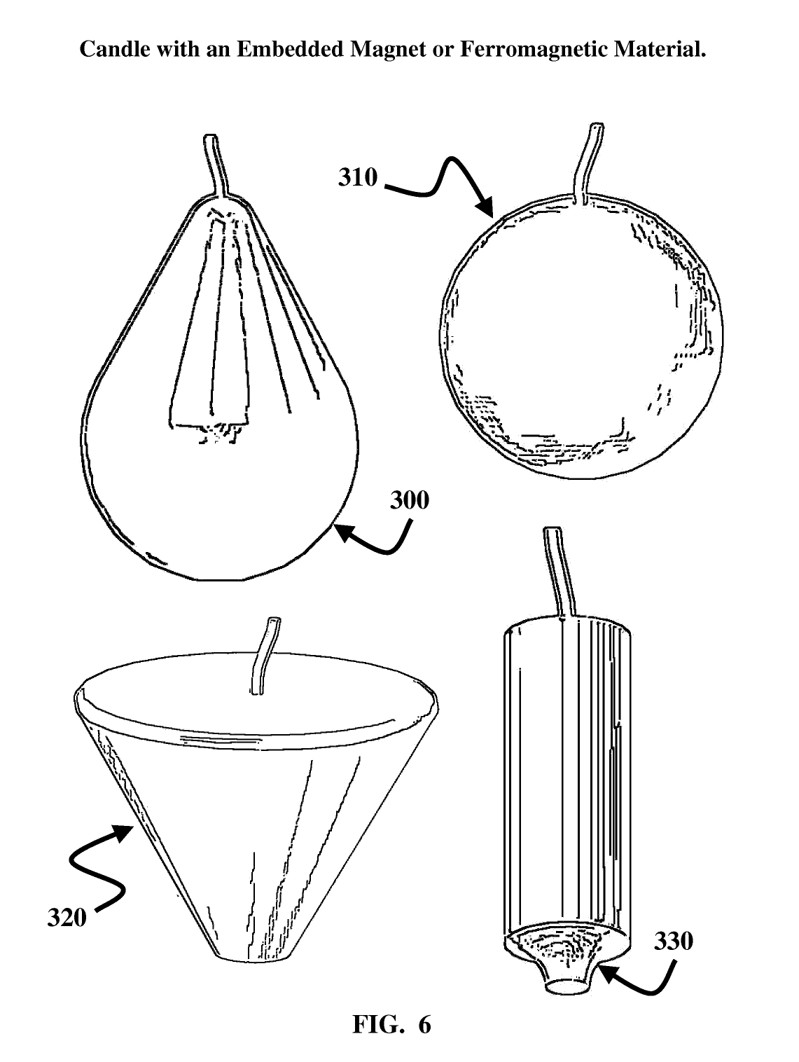

Figure one shows a candle (10), with a base (20). Within the base is a small magnet (30). A section of the base (20) is removed and associated wick are hidden in FIG. 1 to better display magnet (30). The present invention is directed to a candle (10) with an embedded magnet (20). The magnet is embedded near the base of the candle some distance (40). Not shown is an aspect where the flat surface of the cylindrical magnet is substantially flush with the bottom of the base of the candle. The magnets (or ferromagnetic materials) shown in figures one through five are illustrated as cylindrical but may be of other forms including, but not limited to, squares, plates, bars, rings, or other irregularly shaped objects naturally magnetic rocks.

Figure two shows another aspect, where the magnet is irregularly shaped (50) so that a wide cross section retains the magnet within the candle when moderate tensile or side loads are placed on the candle. Figure two also depicts a wick (60) embedded in the candle (70) such that it ends some distance (80) from the magnet (50) such that the wick is exhausted and the flame is extinguished prior to softening the structural integrity of the wax near the magnet, thereby increasing the safety of the invention.

Figure three shows various irregularly shaped magnet including disks (100) with some number of holes (110), cylindrical magnets with some number of transverse holes (120), and magnets with tapered (90) or varied (130) sides. Irregularly shaped magnets do not necessarily need to be round and can be pyramidal, cubic, or any other faceted body with any number of wax retaining features such as holes, pockets, knurling, or bumps.

Figure four shows a multitude of magnets (140) embedded in a candle with the axis of each magnet poles (170) are normal to the long axis (180) of the candle, allowing the candle to be retained from the side (150) rather than the bottom or base of the candle (160). Although a multitude of magnets are shown, as few as one magnet may be used. The wick is hidden to better show the magnets (140).

Figure five demonstrates the utilization of a magnet (190) with a larger piece of ferromagnetic material attracted to and imbedded within the candle (200) to improve retention without needing irregularly shaped magnets as illustrated in figure three. The embodiment of the second piece of material includes, but is not limited to, thin sheets (210) and hollow tubes (220). In the case of the thin sheet, the plane of the sheet is attracted to the magnet (190) and held normal to the axis of the magnet (230). The tube axis (240) is held substantially perpendicular to the axis of the magnet (230). To aid wick placement during fabrication, the wick may be secured to the larger piece of material. For example, the wick (250) may be secured to the tube (220).

Figure six shows a multitude of unusually shaped candles that could not ordinarily be safely used without candles utilizing magnetic attraction to some substrate. In each case, an ordinary candle of similar shape is unstable and may fall. These shapes include, but are not limited to, round bottom (300) or spherical (310) candles, inverted cones (320), or tapered bottom (330) candles.

What is claimed is:

1. A method of orienting and retaining a candle with respect to a base, holder, or surface comprising:
1.) A candle body and at least one magnet embedded and retained within the candle body.
2.) The invention of claim 1 wherein face of said magnet is substantially flush with the base of the candle.
3.) The invention of claim 1 wherein said magnet is within close proximity of the base.
4.) The invention of claim 1 wherein said magnet protrudes from the base or any other surface of the candle.
5.) The invention of claim 1 wherein magnet poles are not coaxial with the long or wick axis of the candle.
6.) The invention of claim 1 wherein the magnet has a greater cross sectional area away from the bottom base.
7.) The invention of claim 1 wherein said candle has a wick which does not extend to the magnet in the base of the candle.
8.) The invention of claim 1 wherein the magnet has an irregular cross sectional area.
9.) The invention of claim 1 wherein the magnet is attracted to or otherwise substantially affixed to a larger ferromagnetic member which is also retained within the candle body.
10.) The invention of claim 1 wherein the magnet is attracted to or otherwise substantially affixed to a larger ferromagnetic member which that is also retained within the candle body wherein the wick is secured to the larger ferromagnetic member.
11.) A candle body and at least one piece of ferromagnetic material embedded and retained within the candle body.
12.) The invention of claim 11 wherein face of said ferromagnetic material is substantially flush with the base of the candle.
13.) The invention of claim 11 wherein said ferromagnetic material is within close proximity of the base.
14.) The invention of claim 11 wherein said ferromagnetic material protrudes from the base or any other surface of the candle.
15.) The invention of claim 11 wherein the ferromagnetic material has a greater cross sectional area away from the bottom base.
16.) The invention of claim 11 wherein said candle has a wick which does not extend to the ferromagnetic material in the base of the candle.
17.) The invention of claim 11 wherein the ferromagnetic material has an irregular cross sectional area.
18.) The invention of claim 11 wherein the ferromagnetic material is attracted to or otherwise substantially affixed to a larger magnet which is also retained within the candle body.
19.) The invention of claim 11 wherein the ferromagnetic material is attracted to or otherwise substantially affixed to a larger magnet that is also retained within the candle body wherein the wick is secured to said magnet.
